(19) United States
(12) Patent Application Publication
(10) Pub. No.: US 2020/0042574 A1
(43) Pub. Date: Feb. 6, 2020

(54) VEGETATION EFFECT QUANTIFICATION DEVICE, QUANTIFICATION SYSTEM, AND STORAGE MEDIUM

(71) Applicant: NEC CORPORATION, Tokyo (JP)

(72) Inventors: Sho ASANO, Tokyo (JP); Shinji KASAHARA, Tokyo (JP)

(73) Assignee: NEC CORPORATION, Tokyo (JP)

(21) Appl. No.: 16/498,163

(22) PCT Filed: Mar. 19, 2018
(86) PCT No.: PCT/JP2018/010751

§ 371 Date: Sep. 26, 2019

(30) Foreign Application Priority Data
Mar. 31, 2017 (JP) 2017-071072

(51) Int. Cl. G06F 17/18; E02D 17/20; E02D 3/12; G16Z 99/00; A01G 7/00

(52) U.S. Cl. CPC G06F 17/18; E02D 17/20; A01G 7/00; G16Z 99/00; E02D 3/12

(57) ABSTRACT

A vegetation effect calculation device includes a memory configured to store instruction and at least one processor configured to execute the instructions to acquire a vegetation parameter being information indicating a characteristic of vegetation flourishing on a slope; and calculate vegetation adhesion per unit area and a total tree weight per unit area, based on the vegetation parameter, a first regression equation being a regression equation between a root diameter and an uprooting resistance, a second regression equation being a regression equation between a breast high diameter and a total tree weight, and a relationship between the uprooting resistance and vegetation adhesion.

### TECHNICAL FIELD

The present disclosure relates to a stability analysis of a slope, and particularly relates to a technique for quantifying a vegetation effect in a slope failure.

### BACKGROUND ART

In construction of a road or a railway, land formation, and construction of a dam and a bank, an artificial slope is formed by cutting or banking. Further, many buildings are present near a natural slope in a mountainous region or on a hilly terrain because the mountainous region and the hilly terrain account for approximately 70% of the land in Japan. The slope carries a danger of a slope failure (a landslip and a landslide).

As one of techniques for avoiding or reducing a danger of such a slope failure, a slope stability analysis is utilized. The slope stability analysis is a technique for checking stability of a slope by analyzing a balance between sliding force of a certain object on the slope and resisting force by friction. The slope stability analysis includes a method such as a Fellenius method, a Janbu method, and a Bishop method.

A natural slope is not constituted of uniform soil, but includes vegetation such as trees. Then, such vegetation may cause stability of a slope to be varied. The following operation may be performed as one example of a method of examining stability of a slope on which vegetation flourishes.
1. Get a tree species and distribution of trees flourishing on a slope (Step 1).
2. Estimate a diameter of a root of a tree extending to a layer deeper than a sliding surface in a soil cross section (Step 2).
3. Measure force required for pulling out the root of the tree (Step 3). The measurement is performed for each tree species and for each diameter of a root.
4. Quantify an effect of a tree on stability of the slope, based on the measurement result and the distribution of the trees (Step 4).

One example of the method of examining stability of a slope on which vegetation flourishes described above needs an experiment and the other work, thereby requiring a long time.

### CITATION LIST

### Patent Literature

[PTL 1] International Patent Publication No. WO2016/027291

### SUMMARY OF INVENTION

### Technical Problem

PTL 1 describes a technique for calculating a parameter of soil, based on a characteristic (a clod weight, an internal frictional angle, adhesion) of the soil and gap water pressure (a measurement value previously acquired by experiment) between soil particles, and calculating stability of a slope by performing a slope stability analysis from the calculated parameter of the soil and an amount of moisture (an instant measurement value by a moisture sensor buried in the soil) in the soil.

In the technique described in PTL 1, it is assumed that a slope is uniform soil for performing a slope stability analysis. In other words, an effect of vegetation on stability of a slope cannot be quantified in the technique described in PTL 1.

An object of the present disclosure is to provide a device and the like that quantify an effect of vegetation on stability of a slope.

### Solution to Problem

A vegetation effect calculation device according to the present disclosure includes:

acquisition means for acquiring a vegetation parameter being information indicating a characteristic of vegetation flourishing on a slope; and

vegetation effect calculation means for calculating vegetation adhesion per unit area and a total tree weight per unit area, based on the vegetation parameter, a first regression equation being a regression equation between a root diameter and an uprooting resistance, a second regression equation being a regression equation between a breast high diameter and a total tree weight, and a relationship between the uprooting resistance and vegetation adhesion.

A vegetation effect calculation system according to the present disclosure includes:

a recording medium; a vegetation effect calculation device; and a slope stability analysis device, wherein

the recording medium previously records, as a database, a vegetation parameter being a tree species, a breast high diameter, or a distance between trees in a predetermined region,

the vegetation effect calculation device includes acquisition means, vegetation effect calculation means, and output means,

the acquisition means acquires a vegetation parameter being information indicating a characteristic of vegetation flourishing on a slope,

the vegetation effect calculation means calculates vegetation adhesion per unit area and a total tree weight per unit area, based on the vegetation parameter acquired by the acquisition means, a first regression equation being a regression equation between a root diameter and an uprooting resistance, a second regression equation being a regression equation between a breast high diameter and a total tree weight, and a relationship between the uprooting resistance and vegetation adhesion,

the output means outputs the vegetation adhesion per unit area and the total tree weight per unit area, being calculated by the vegetation effect calculation means, to the slope stability analysis device, and

the slope stability analysis device calculates a safety factor of a slope in a predetermined region, by using the calculated vegetation adhesion per unit area and the calculated total tree weight per unit area.

A vegetation effect calculation method according to the present disclosure includes:

acquiring a vegetation parameter being information indicating a characteristic of vegetation flourishing on a slope; and

calculating vegetation adhesion per unit area and a total tree weight per unit area, based on the acquired vegetation parameter, a first regression equation being a regression equation between a root diameter and an uprooting resistance, a second regression equation being a regression equation between a breast high diameter and a total tree weight, and a relationship between the uprooting resistance and vegetation adhesion.

A storage medium that stores a program causing a computer to function as:

means for acquiring a vegetation parameter being information indicating a characteristic of vegetation flourishing on a slope; and

means for calculating vegetation adhesion per unit area and a total tree weight per unit area, based on the acquired vegetation parameter, a first regression equation being a regression equation between a root diameter and an uprooting resistance, a second regression equation being a regression equation between a breast high diameter and a total tree weight, and a relationship between the uprooting resistance and vegetation adhesion.

### Advantageous Effects of Invention

The present disclosure is able to provide a process of quantifying an effect of vegetation on stability of a slope.

### BRIEF DESCRIPTION OF DRAWINGS

FIG. 1 is a block diagram illustrating a functional configuration of a vegetation effect calculation device 100 according to a first example embodiment.

FIG. 2 is a flowchart illustrating one example of an operation of the vegetation effect calculation device 100 according to the first example embodiment.

FIG. 3 is a block diagram illustrating a functional configuration of a vegetation effect calculation unit 120 according to the first example embodiment.

FIG. 4 is a block diagram illustrating a functional configuration of a vegetation effect calculation system 20 according to a second example embodiment.

FIG. 5 is a data flowchart illustrating one example of an operation of a vegetation effect calculation device 100 according to the second example embodiment.

FIG. 6 is a block diagram illustrating one example of a hardware configuration of a computer device 300 according to an example embodiment.

### Example Embodiment

Hereinafter, example embodiments are described in detail with reference to drawings. Note that, in the following description, a component having the same function is denoted by the same reference sign, and description thereof may be omitted.

### First Example Embodiment

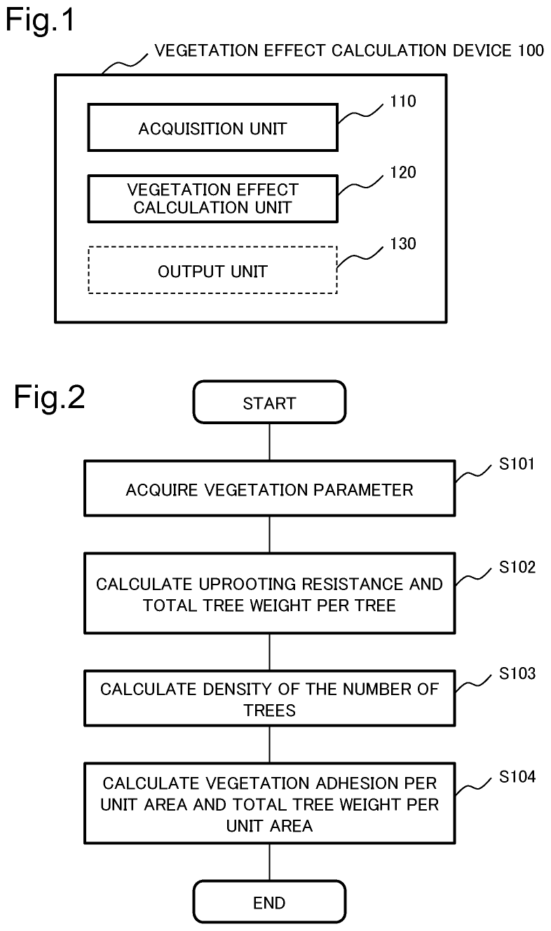

FIG. 1 is a block diagram illustrating a functional configuration of a vegetation effect calculation device 100 according to a first example embodiment. The vegetation effect calculation device 100 is an information processing device that calculates an effect of vegetation on stability of a slope. The vegetation effect calculation device 100 includes at least an acquisition unit 110 and a vegetation effect calculation unit 120. Furthermore, the vegetation effect calculation device 100 may include an output unit 130.

The acquisition unit 110 acquires information (vegetation parameter) indicating a characteristic of vegetation (hereinafter, vegetation) flourishing on a slope. At this time, the acquisition unit 110 acquires data from a storage medium or another device included in the vegetation effect calculation device 100.

The vegetation parameter is, for example, a tree species, a breast high diameter, a distance between trees, and a root diameter. The tree species is a species of a tree (hereinafter, a tree) being vegetation. The breast high diameter is a diameter of a tree at a height position of a breast of an adult. The distance between trees is a distance between a plurality of trees. The root diameter is a diameter of a root portion of a tree. The acquisition unit 110 may acquire data different from the data mentioned above as the vegetation parameter. The root diameter has a high correlation with the breast high diameter, and the root diameter may be calculated using the tree species and the breast high diameter.

The vegetation effect calculation unit 120 calculates vegetation adhesion per unit area and a total tree weight per unit area using the vegetation parameter acquired by the acquisition unit 110, a first regression equation, and a second regression equation.

The vegetation adhesion is force of binding soil layers by the vegetation. The vegetation adhesion may be referred to as soil binding force or binding force. The vegetation adhesion is one of parameters indicating an effect of vegetation on stability of a slope. A slope is less likely to collapse with greater vegetation adhesion. The vegetation adhesion per tree can be acquired from an uprooting resistance. As one of the simplest methods of acquiring the vegetation adhesion, there is a method of using a value of an uprooting resistance as the vegetation adhesion without any change. The uprooting resistance is force required for pulling out a root of a tree from soil.

The total tree weight is a weight (including all leaf, branch, trunk, and root) of the entire tree being vegetation.

When a tree is a live tree, a weight of moisture held in the tree may be included in the total tree weight. The total tree weight is one of parameters indicating an effect of vegetation on stability of a slope. A slope is more likely to collapse with a greater total tree weight. The first regression equation is a regression equation between the root diameter and the uprooting resistance. The first regression equation is generated for each tree species. The second regression equation is a regression equation between the breast high diameter and the total tree weight. The second regression equation is generated for each tree species.

The output unit 130 outputs the vegetation adhesion per unit area and the total tree weight per unit area being calculated by the vegetation effect calculation unit 120 to an external device and the like. The vegetation adhesion and the total tree weight per unit area are used for calculating a safety factor in another device, for example.

FIG. 2 is a flowchart illustrating one example of an operation of the vegetation effect calculation device 100 according to the first example embodiment. Note that the vegetation effect calculation device 100 may change an order of performing steps illustrated in FIG. 2 within bounds that inconsistency does not occur in action and an effect.

The acquisition unit 110 acquires a vegetation parameter (Step S101). At this time, the acquisition unit 110 acquires data from a storage medium or another device included in the vegetation effect calculation device 100.

The vegetation effect calculation unit 120 calculates an uprooting resistance and a total tree weight per tree, using the vegetation parameter acquired by the acquisition unit 110, a first regression equation, and a second regression equation (Step S102).

The vegetation effect calculation unit 120 calculates a density of the number of trees using a distance between the trees acquired by the acquisition unit 110 (Step S 103). The density of the number of trees is the number of trees flourishing on a slope per unit area.

The vegetation effect calculation unit 120 calculates vegetation adhesion and a total tree weight of the trees per unit area using the uprooting resistance, the total tree weight per tree, and the density of the number of trees (Step S104).

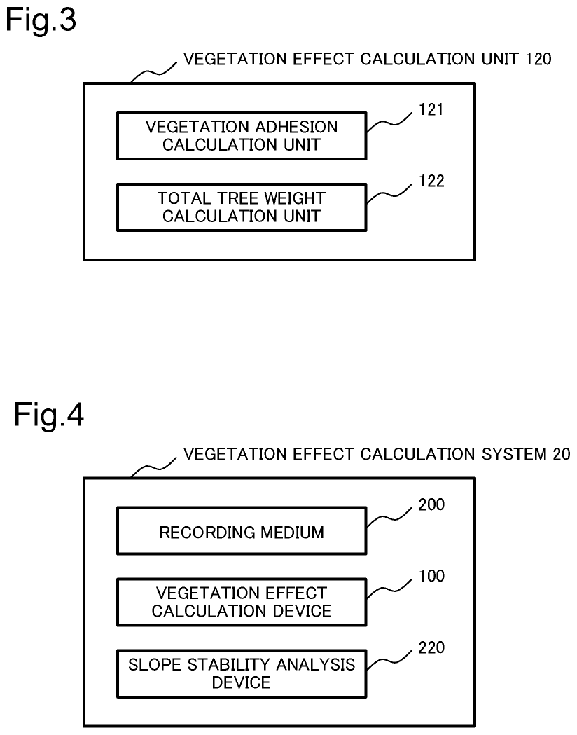

FIG. 3 is a block diagram illustrating a functional configuration of the vegetation effect calculation unit 120 according to the first example embodiment. The vegetation effect calculation device 100 includes at least a vegetation adhesion calculation unit 121 and a total tree weight calculation means 122.

The vegetation adhesion calculation unit 121 calculates vegetation adhesion per unit area using a vegetation parameter and a first regression equation. More specifically, the vegetation adhesion calculation unit 121 calculates a root diameter by using a breast high diameter for each tree species acquired by the acquisition unit 110, and calculates an uprooting resistance by using the first regression equation acquired by the acquisition unit 110 and the calculated root diameter. Furthermore, the vegetation adhesion calculation unit 121 calculates the vegetation adhesion per unit area by using a distance between trees acquired by the acquisition unit 110 and the calculated uprooting resistance.

The total tree weight calculation unit 122 calculates vegetation adhesion per unit area by using a vegetation parameter and a second regression equation. More specifically, the total tree weight calculation unit 122 calculates a total tree weight per tree by using the second regression equation and a breast high diameter for each tree species being acquired by the acquisition unit 110.

Furthermore, the total tree weight calculation unit 122 calculates a total tree weight per unit area by using a distance between trees acquired by the acquisition unit 110 and the calculated total tree weight per tree.

One example of the operation of the vegetation effect calculation device 100 according to the first example embodiment is described above. The present example embodiment is able to quantify an effect of vegetation on stability of a slope in a predetermined region by measuring a tree species, a breast high diameter, and a distance between trees. The predetermined region is, for example, a region in which a sediment disaster such as a slope failure is likely to occur.

### Second Example Embodiment

FIG. 4 is a block diagram illustrating a functional configuration of a vegetation effect calculation system 20 according to a second example embodiment. The vegetation effect calculation system 20 includes at least a recording medium 200, a vegetation effect calculation device 100, and a slope stability analysis device 220. The vegetation effect calculation device 100 includes at least an acquisition unit 110, a vegetation effect calculation unit 120, and an output unit 130.

The vegetation effect calculation system 20 is a system that calculates stability of a slope while taking an effect of vegetation in a predetermined region on the stability of the slope into account.

The recording medium 200 previously records, as a database, a vegetation parameter (a tree species, a breast high diameter, a distance between trees) in a predetermined region. Further, the recording medium 200 previously records a first regression equation (an uprooting resistance and a root diameter for each tree species) and a second regression equation (a total tree weight and a breast high diameter for each tree species).

The vegetation effect calculation unit 120 reads the vegetation parameter and the regression equation from the recording medium 200, and calculates an uprooting resistance and a total tree weight per tree.

The vegetation effect calculation unit 120 calculates “vegetation adhesion per unit area” by using the uprooting resistance and a distance between trees.

Similarly, the vegetation effect calculation unit 120 calculates a “total tree weight per unit area” by using the total tree weight per tree and the distance between trees.

The vegetation effect calculation unit 120 calculates the “vegetation adhesion per unit area” and the “total tree weight per unit area” by using, for example, Equation 1 and Equation 2 below.

$$\begin{matrix}[ Equation 1 ] & \\ {C}_{p} = \frac{c 1 \cdot ( √ 3 \cdot {d}^{2} )}{2} & Equation 1 \\ [ Equation 2 ] & \\ Wp = \frac{W 1 \cdot ( 3 \cdot {d}^{2} )}{2} & Equation 2\end{matrix}$$

Herein, d is a distance between trees, c1 is vegetation adhesion per tree, W1 is a total tree weight per tree, cp is vegetation adhesion per unit area, and wp is a total tree weight per unit area. As described above, the vegetation adhesion per tree can be acquired from an uprooting resistance.

The slope stability analysis device 220 calculates a safety factor of a slope in a predetermined region by using the calculated vegetation adhesion per unit area and the calculated total tree weight per unit area.

The slope stability analysis device 220 calculates a safety factor by using a slope stability analysis equation as expressed in, for example, Equation 3 below.

$$\begin{matrix}[ Equation 3 ] & \\ Fs = \frac{\sum \{ c l + {c}_{v} l + ( W + {W}_{v} - ub ) cos α \cdot tan ϕ \}}{\sum ( W + {W}_{v} ) \cdot sin α} & Equation 3\end{matrix}$$

Herein, Fs is a safety factor, c is adhesion of soil constituting a slope, cv is vegetation adhesion, W is a weight of the soil constituting the slope, Wv is a total tree weight, α is a gradient of the slope, φ is an internal frictional angle of the soil, u is gap water pressure, I is a sliding surface length of a divided piece, and b is a width of a slice.

The slope stability analysis device 220 converts the vegetation adhesion cp and the total tree weight wp calculated in Equation 1 and Equation 2 into vegetation adhesion cv and a total tree weight Wv according to a unit system of Equation 3.

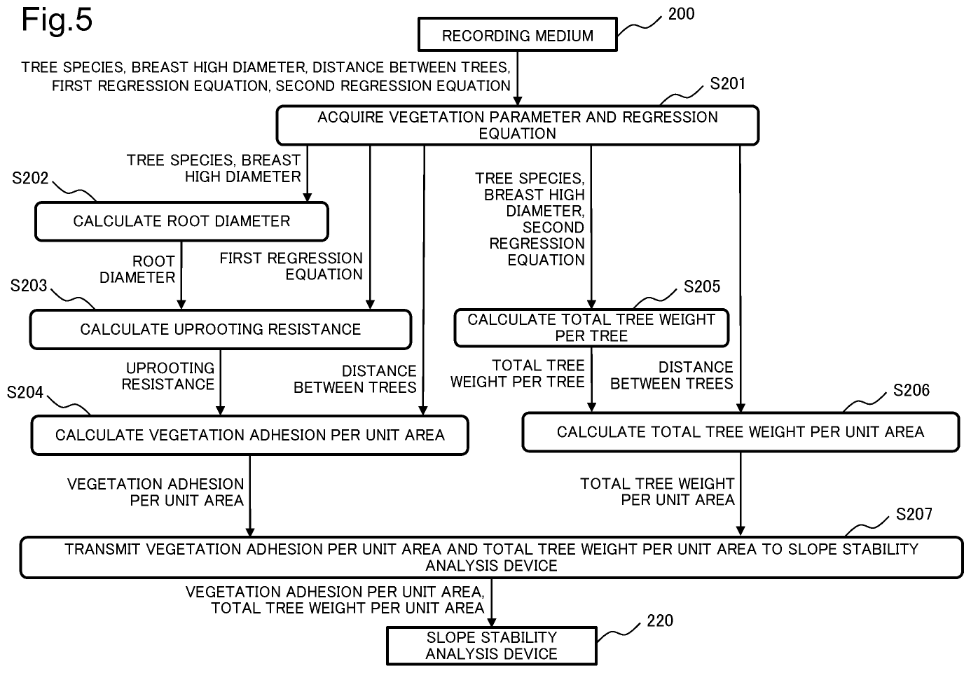

FIG. 5 is a data flowchart illustrating one example of an operation of the vegetation effect calculation device 100 according to the second example embodiment.

The acquisition unit 110 reads, from the recording medium 200, a vegetation parameter (a tree species, a breast high diameter, a distance between trees) and a regression equation (a first regression equation, a second regression equation) needed for calculating an effect of vegetation on stability of a slope (Step S201). At this time, data for each tree species are read for the breast high diameter. Further, data for each tree species or average data without distinction of tree species are read for the distance between trees.

The vegetation adhesion calculation unit 121 calculates a root diameter by using the breast high diameter for each tree species read by the acquisition unit 110 (Step S202).

The vegetation adhesion calculation unit 121 calculates an uprooting resistance by using the first regression equation read by the acquisition unit 110 and the root diameter calculated in Step S202 (Step S203).

The vegetation adhesion calculation unit 121 calculates vegetation adhesion per unit area by using the distance between trees read by the acquisition unit 110 and the uprooting resistance calculated in Step S203 (Step S204).

The total tree weight calculation unit 122 calculates a total tree weight per tree by using the second regression equation and the breast high diameter for each tree species read by the acquisition unit 110 (Step S205).

The total tree weight calculation unit 122 calculates a total tree weight per unit area by using the distance between trees read by the acquisition unit 110 and the total tree weight per tree calculated in Step S205 (Step S206).

The output unit 130 transmits the vegetation adhesion per unit area calculated by the vegetation adhesion calculation unit 121 and the total tree weight per unit area calculated by the total tree weight calculation unit 122 to the slope stability analysis device 220 (Step S207). In Step S207, the output unit 130 may transmit via the recording medium and the like once instead of directly transmitting them to the slope stability analysis device 220.

Roots of various species are mixed and distributed on an actual slope. Then, when the acquisition unit 110 reads data about a distance between trees for each tree species in Step S201, a plurality of calculations are performed on each tree species by using the data about a distance between trees for each tree species in each step from Step S202 to Step S206. Then, in Step S207, the output unit 130 sets a sum total of vegetation adhesion per unit area for each tree species as vegetation adhesion per unit area of a slope in a predetermined region. Further, in Step S207, the output unit 130 sets a sum total of total tree weights per unit area for each tree species as a total tree weight per unit area of the slope in the predetermined region.

Alternatively, when the acquisition unit 110 reads average data about a distance between trees without distinction of tree species in Step S201, a plurality of calculations are performed on each tree species by using the average data about a distance between trees without distinction of tree species in each step from Step S202 to Step S206. Then, in Step S207, the output unit 130 sets a sum total acquired by multiplying vegetation adhesion per unit area for each tree species by a ratio of distribution for each tree species as vegetation adhesion per unit area of a target slope. Further, in Step S207, the output unit 130 sets a sum total acquired by multiplying total tree weights per unit area for each tree species by the ratio of the distribution for each tree species as a total tree weight per unit area of the target slope.

One example of the operation of the vegetation effect calculation device 100 according to the second example embodiment is described above. The present example embodiment is able to quantify an effect of vegetation on stability of a slope by measuring a tree species, a breast high diameter, and a distance between trees in a predetermined region. Furthermore, the present example embodiment is able to calculate a safety factor of the slope, based on the effect of the vegetation on the stability of the slope.

### (Hardware Configuration)

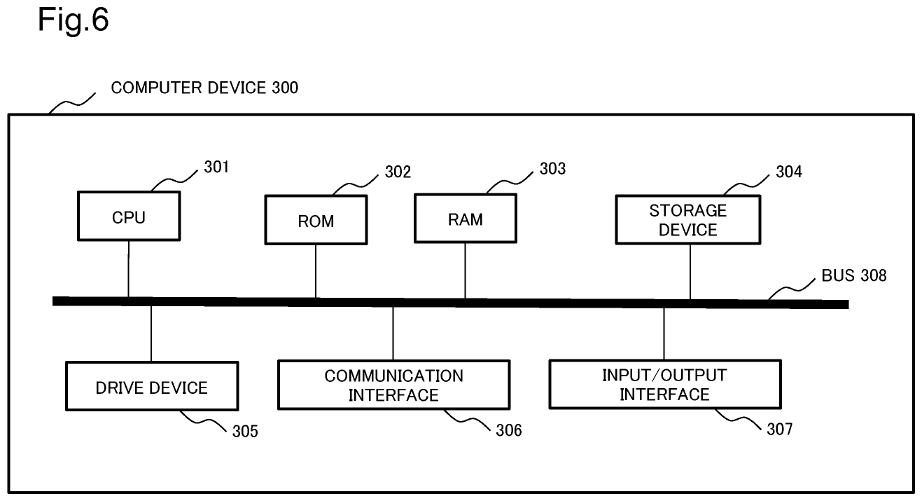

FIG. 6 is a block diagram illustrating one example of a hardware configuration of a computer device 300 according to an example embodiment. The computer device 300 is one example of a device that achieves the vegetation effect calculation device 100 and the slope stability analysis device 220 described above. The computer device 300 includes a central processing unit (CPU) 301, a read only memory (ROM) 302, a random access memory (RAM) 303, a storage device 304, a drive device 305, a communication interface 306, and an input/output interface 307. The CPU 301, the ROM 302, the RAM 303, the storage device 304, the drive device 305, the communication interface 306, and the input/output interface 307 are connected to one another via a bus 308. The vegetation effect calculation device 100 and the slope stability analysis device 220 may be achieved by the configuration (or a part thereof) illustrated in FIG. 6.

The CPU 301 executes a program by using the RAM 303. The CPU 301, the RAM 303, and the program can function as a calculation means. The program may be stored in the ROM 302. Further, the program may be recorded in a recording medium 309 such as a flash memory and read by the drive device 305, or may be transmitted from an external device via a network 310. The communication interface 306 exchanges data with the external device via the network 310. The input/output interface 307 exchanges data with a peripheral apparatus (such as an input device, a display device, a measuring instrument, and a sensor). The communication interface 306 and the input/output interface 307 may function as a means for acquiring or outputting data.

Note that, each function unit of the acquisition unit 110, the vegetation effect calculation unit 120, the output unit 130, and the like may be constituted of a single circuit (such as a processor) or a combination of a plurality of circuits. The circuit (circuitry) herein may be either a dedicated or a general-purpose circuit. Further, the acquisition unit 110, the vegetation effect calculation unit 120, the output unit 130, and the like may be constituted of a single circuit.

Various modifications can be made within the scope of the invention described in claims without limiting the present disclosure to the above-described example embodiments, and it is needless to say that the modifications are also included in the scope of the invention. Various aspects that can be understood by those skilled in the art may be applied within the scope of the present disclosure.

This application is based upon and claims the benefit of priority from Japanese patent application No. 2017-071072, filed on Mar. 31, 2017, the disclosure of which is incorporated herein in its entirety by reference.

### REFERENCE SIGNS LIST

100 Vegetation effect calculation device
110 Acquisition unit
120 Vegetation effect calculation unit
20 Vegetation effect calculation system
200 Recording medium
220 Slope stability analysis device
300 Computer device
301 Central processing unit (CPU)
302 Read only memory (ROM)
303 Random access memory (RAM)
304 Storage device
305 Drive device
306 Communication interface
307 Input/output interface
308 Bus
309 Recording medium
310 Network

1. A vegetation effect calculation device, comprising:
a memory configured to store instruction; and
at least one processor configured to execute the instructions to:
acquire a vegetation parameter being information indicating a characteristic of vegetation flourishing on a slope; and
calculate vegetation adhesion per unit area and a total tree weight per unit area, based on the vegetation parameter, a first regression equation being a regression equation between a root diameter and an uprooting resistance, a second regression equation being a regression equation between a breast high diameter and a total tree weight, and a relationship between the uprooting resistance and vegetation adhesion.

2. The vegetation effect calculation device according to claim 1, further comprising:
the at least one processor configured to execute the instructions to:
calculate vegetation adhesion per unit area, based on the vegetation parameter, the first regression equation, and a relationship between the uprooting resistance and vegetation adhesion; and
calculate the total tree weight per unit area, based on the vegetation parameter and the second regression equation.

3. The vegetation effect calculation device according to claim 2, wherein
the at least one processor configured to execute the instructions to:
calculate a root diameter by using a breast high diameter for each tree species being a vegetation parameter acquired,
calculate an uprooting resistance by using a first regression equation acquired and the calculated root diameter, and
calculate vegetation adhesion per unit area by using a distance between trees being a vegetation parameter acquired, the calculated uprooting resistance, and a relationship between the uprooting resistance and vegetation adhesion.

4. The vegetation effect calculation device according to claim 2, wherein
the at least one processor configured to execute the instructions to:
calculate a total tree weight per tree by using a second regression equation and a breast high diameter for each tree species being a vegetation parameter that are acquired, and
calculate a total tree weight per unit area by using a distance between trees being a vegetation parameter acquired and the calculated total tree weight per tree.

5. The vegetation effect calculation device according to claim 1, wherein
the at least one processor configured to execute the instructions to:
calculate, for each tree species, a plurality of the vegetation adhesion per unit area and a plurality of the total tree weights per unit area, by using a piece of data about a distance between trees for each tree species,
set a sum total of the plurality of calculated vegetation adhesion per unit area as vegetation adhesion per unit area of a slope in a predetermined region, and
set a sum total of the plurality of calculated total tree weights per unit area as a total tree weight per unit area of a slope in a predetermined region.

6. The vegetation effect calculation device according to claim 1, wherein
the at least one processor configured to execute the instructions to:
calculate, for each tree species, a plurality of the vegetation adhesion per unit area and a plurality of the total tree weights per unit area, by using a piece of data about an average distance between trees without distinction of tree species,
set a sum total acquired by multiplying the plurality of calculated vegetation adhesion per unit area by a ratio of distribution for each tree species as vegetation adhesion per unit area of a target slope, and
set a sum total acquired by multiplying the plurality of calculated total tree weights per unit area by a ratio of distribution for each tree species as a total tree weight per unit area of a target slope.

7. The vegetation effect calculation device according to claim 1, wherein
the vegetation parameter is a tree species, a breast high diameter, or a distance between trees.

8. (canceled)

9. A vegetation effect calculation method, comprising:
acquiring a vegetation parameter being information indicating a characteristic of vegetation flourishing on a slope; and
calculating vegetation adhesion per unit area and a total tree weight per unit area, based on the acquired vegetation parameter, a first regression equation being a regression equation between a root diameter and an uprooting resistance, a second regression equation being a regression equation between a breast high diameter and a total tree weight, and a relationship between the uprooting resistance and vegetation adhesion.

10. A non-transitory computer readable storage medium that stores a program causing a computer to function as:
means for acquiring a vegetation parameter being information indicating a characteristic of vegetation flourishing on a slope; and
means for calculating vegetation adhesion per unit area and a total tree weight per unit area, based on the acquired vegetation parameter, a first regression equation being a regression equation between a root diameter and an uprooting resistance, a second regression equation being a regression equation between a breast high diameter and a total tree weight, and a relationship between the uprooting resistance and vegetation adhesion.
